(19) United States
(12) Patent Application Publication
(10) Pub. No.: US 2017/0271672 A1
(43) Pub. Date: Sep. 21, 2017

(54) ANODE MATERIALS FOR MAGNESIUM BATTERIES AND METHOD OF MAKING SAME

(71) Applicant: 3M INNOVATIVE PROPERTIES COMPANY, St. Paul, MN (US)

(72) Inventors: Mark N. Obrovac, Halifax (CA); Tuan T. Tran, Union City, CA (US); Mary I. Purcell, Lunenburg (CA)

(21) Appl. No.: 15/528,953

(22) PCT Filed: Nov. 18, 2015
(86) PCT No.: PCT/US15/61242

§ 371 Date: May 23, 2017

Related U.S. Application Data
(60) Provisional application No. 62/084,631, filed on Nov. 26, 2014.

(51) Int. Cl. H01M 4/56; H01M 10/054; H01M 4/46

(52) U.S. Cl. CPC H01M 4/56; H01M 4/466; H01M 10/054; H01M 2004/027

(57) ABSTRACT

An electrochemically active material includes an electrochemically active phase that includes elemental lead. The electrochemically active material includes at least 20 atomic % elemental lead based on the total chemical composition of the electrochemically active material. In some embodiments, an electrochemically active material is provided. The electrochemically active material includes an electrochemically active phase that includes elemental lead. The electrochemically active material includes at least 20 atomic % elemental lead based on the total chemical composition of the electrochemically active material.

### FIELD

The present disclosure relates to compositions useful in anodes for magnesium batteries and methods for preparing and using the same.

### BACKGROUND

Various anode compositions have been introduced for use in secondary magnesium batteries. Such compositions are described, for example, in Nikhilendra Singh et al., Chem. Commun. 49 (2013) 149, and Timothy S. Arthur, Nikhilendra Singh, and Masaki Matsui, Electrochem. Commun., 16 (2012) 103.

### SUMMARY

In some embodiments, an electrochemically active material is provided. The electrochemically active material includes an electrochemically active phase that includes elemental lead. The electrochemically active material includes at least 20 atomic % elemental lead based on the total chemical composition of the electrochemically active material.

In some embodiments, a magnesium battery is provided. The battery includes a positive electrode that includes a positive electrode composition. That battery further includes an electrolyte that includes magnesium. The battery further includes a negative electrode that includes a negative electrode composition that includes the above-described electrochemically active material.

In some embodiments, a method of making a magnesium battery is provided. The method includes providing a positive electrode that includes a positive electrode composition. The method further includes providing a negative electrode that includes a negative electrode composition that includes the above-described electrochemically active material. The method further includes providing an electrolyte that includes magnesium. The method further includes incorporating the positive electrode, negative electrode, and the electrolyte into a battery.

The above summary of the present disclosure is not intended to describe each embodiment of the present invention. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 shows the voltage curve for the electrochemical cell of Example 1;

FIG. 2 shows the capacity vs. cycle number for the electrochemical cell of Example 1.

FIG. 3 shows the X-ray diffraction pattern for the negative electrode composition of Example 1, after removal from a fully discharged electrochemical cell.

FIG. 4 shows the X-ray diffraction pattern for the negative electrode composition of Example 1, after removal from a fully electrochemical cell that was fully discharged, and then charged.

FIG. 5 shows the voltage curve for the electrochemical cell of Example 2;

FIG. 6 shows the capacity vs. cycle number for the electrochemical cell of Example 2.

### DETAILED DESCRIPTION

Magnesium batteries (which, for the purposes of the present disclosure include both Magnesium and Magnesium-ion batteries), in theory, may have higher energy densities than lithium-ion batteries. However, magnesium metal cannot be plated or stripped from most conventional polar organic solvents. Currently, Grignard reagents are used to reversibly strip and plate magnesium. However, such electrolytes are highly toxic and highly flammable. Other electrolyte solvents have been suggested for use in magnesium batteries, but the nature of the magnesium deposits is not fully characterized. Consequently, identification of host materials for magnesium at the negative electrode that might be active in a broader range of electrolyte solvents, and that might avoid any dendritic magnesium produced by repeated plating and stripping of magnesium metal, is desirable.

It has been shown that electrodes comprising elements that can alloy with magnesium can be utilized as negative electrode materials in magnesium batteries. In contrast to a pure Mg electrode, such alloy electrodes have been shown to operate in conventional electrolytes. However, the rate capability of such alloy electrodes can be slow in magnesium cells, resulting in low capacity at charging rates greater than C/100.

Generally, the present application is directed to negative electrode compositions (e.g., for magnesium batteries) that include elemental lead. It has been discovered that lead is an ultra-high energy density material for negative electrodes for magnesium batteries. It is believed that the use of a lead in electrodes for magnesium batteries could enable a wider range of electrolytes and improved safety characteristics for magnesium batteries.

In this document:

the terms “magnesiate” and “magnesiation” refer to a process for adding magnesium to an electrode material;

the terms “de magnesiate” and “de magnesiate” refer to a process for removing magnesium from an electrode material;

the terms “charge” and “charging” refer to a process for providing electrochemical energy to a cell;

the terms “discharge” and “discharging” refer to a process for removing electrochemical energy from a cell, e.g., when using the cell to perform desired work;

the term “cathode” refers to an electrode (often called the positive electrode) where electrochemical reduction and magnesiation occurs during a discharging process;

the term “anode” refers to an electrode (often called the negative electrode) where electrochemical oxidation and demagnesiation occurs during a discharging process;

the term “alloy” refers to a substance that includes any or all of metals, metalloids, semimetals;

the phrase “electrochemically active material” refers to a material, which can include a single phase or a plurality of phases, that reversibly reacts with magnesium under conditions typically encountered during charging and discharging in a magnesium battery;

the phrases “electrochemically active material” or “active material” refer to an active material that is a component of the anode of a magnesium battery;

the phrases “electrochemically active phase” or “active phase” refer to a phase of an electrochemically active material that reversibly reacts with magnesium under conditions typically encountered during charging and discharging in a magnesium battery;

the phrases “electrochemically inactive phase” or “inactive phase” refer to a phase of an electrochemically active material that does not react with magnesium under conditions typically encountered during charging and discharging in a magnesium battery;

the phrases “electrochemically active chemical element” or “active chemical element” refer to chemical elements that reversibly react with magnesium under conditions typically encountered during charging and discharging in a magnesium battery;

the phrases “electrochemically inactive chemical element” or “inactive chemical element” refer to chemical elements that do not react with magnesium under conditions typically encountered during charging and discharging in a magnesium battery;

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure relates to an electrochemically active material for use in a magnesium battery. For example, the electrochemically active material may be incorporated into a negative electrode for a magnesium battery.

In some embodiments, the electrochemically active material may include one or more electrochemically active phases, where the electrochemically active phase may be in the form of or include an active chemical element, an active alloy, or combinations thereof. In some embodiments, the electrochemically active phase may include elemental lead. Additionally, the electrochemically active phase may include Sn, Bi, Sb, P, S, or combinations thereof. In some embodiments, the electrochemically active phase may further include one or more inactive chemical elements, inactive alloys, or combinations thereof, including Ti, V, Cr, Fe, Mn, Fe, and Co. In some embodiments the electrochemically active material may contain Mg.

In some embodiments the electrochemically active material may further include an electrochemically inactive phase, such that the electrochemically active phase and the electrochemically inactive phase share at least one common phase boundary. In various embodiments, the electrochemically inactive phase may be in the form of or include one or more electrochemically inactive chemical elements, including transition metals (e.g., titanium, vanadium, chromium, manganese, iron, cobalt), alkaline earth metals, rare earth metals, or combinations thereof. In various embodiments, the electrochemically inactive phase may be in the form of an alloy. In various embodiments, the electrochemically inactive phase may include a transition metal or combination of transition metals. In some embodiments, the electrochemically inactive phase may further include one or more active chemical elements, including tin, carbon, gallium, indium, silicon, germanium, lead, antimony, bismuth, or combinations thereof. In some embodiments, the electrochemically inactive phase may include compounds such as silicides, aluminides, borides, nitrides or stannides. The electrochemically inactive phase may include oxides, such as titanium oxide, zinc oxide, silicon oxide, aluminum oxide or sodium-aluminum oxide.

In some embodiments, the electrochemically active material may include at least 10 vol. % Pb, at least 40 vol. % Pb, at least 70 vol. % Pb, or at least 90 vol. % Pb, based on the total volume of the electrochemically active material. In some embodiments, the electrochemically active material may include at least 20 atomic % Pb, at least 60 atomic % Pb, at least 80 atomic % Pb, or at least 90 atomic % Pb, based on the total chemical composition of the electrochemically active material. In some embodiments, the electrochemically active material may include no more than 80 vol. % of an inactive phase, no more than 60 vol. % of an inactive phase, no more than 30 vol. % of an inactive phase, or no more than 10% of an inactive phase, based on the total volume of the electrochemically active material. In some embodiments, the electrochemically active material consists essentially of pure Pb.

In some embodiments, the present disclosure is further directed to negative electrode compositions for use in magnesium batteries. The negative electrode compositions may include the above-described electrochemically active materials. Additionally, the negative electrode compositions may include one or more additives such as binders, conductive diluents, fillers, adhesion promoters, thickening agents for coating viscosity modification such as carboxymethylcellulose, polyacrylic acid, polyvinylidene fluoride, lithium polyacrylate, carbon black, and other additives known by those skilled in the art.

In some embodiments, the present disclosure is further directed to negative electrodes for use in magnesium batteries. The negative electrodes may include a current collector having disposed thereon the above-described negative electrode composition. The current collector may be formed of a conductive material such as a metal.

In some embodiments, the present disclosure further relates to magnesium batteries. In addition to the above-described negative electrodes, the magnesium batteries may include a positive electrode that includes a positive electrode composition, and an electrolyte composition that includes magnesium.

In some embodiments, useful positive electrode compositions may include Mo₆S₈, MgMnSiO₄, MgFeSiO₄ or MgCoSiO₄, or any other material known to be useful in positive electrodes for magnesium batteries.

In various embodiments, useful electrolyte compositions may be in the form of a liquid, solid, or gel. The electrolyte compositions may include a salt and a solvent. Examples of solid electrolyte solvents include polymers such as polyethylene oxide, polytetrafluoroethylene, fluorine-containing copolymers, and combinations thereof. Examples of liquid electrolyte solvents include ethylene carbonate, diethyl carbonate, propylene carbonate, fluoroethylene carbonate, tetrahydrofuran (THF), acetonitrile, and combinations thereof. In some embodiments the electrolyte solvent may comprise glymes, including monoglyme, diglyme and higher glymes, such as tetraglyme. Examples of electrolyte salts include magnesium containing salts, such as Mg(PF₆)₂, Mg(ClO₄)₂, Mg[N(SO₂CF₃)₂]₂, Mg(CF₃SO₃)₂ and NaBF₄. In some embodiments the electrolyte salt may include a magnesium halide, including MgCl₂, MgBr₂ or MgF₂ and may further include Lewis acidic compounds, such as AlCl₃. In some embodiments Grignard reagents may be used as electrolytes, including magnesium organohaloaluminates in a tetrahydrofuran (THF) solvent. In some embodiments, the electrolyte compositions described in WO 2013/122783, which is herein incorporated by reference in its entirety, may be used.

In some embodiments, the magnesium batteries may further include a microporous separator, such as a microporous material available from Celgard LLC, Charlotte, N.C. The separator may be incorporated into the battery and used to prevent the contact of the negative electrode directly with the positive electrode.

The disclosed magnesium batteries can be used in a variety of devices including, without limitation, portable computers, tablet displays, personal digital assistants, mobile telephones, motorized devices (e.g., personal or household appliances and vehicles), instruments, illumination devices (e.g., flashlights) and heating devices. One or more magnesium batteries of this disclosure can be combined to provide battery pack.

The present disclosure further relates to methods of making the above-described electrochemically active materials. In some embodiments, the materials can be made by methods known to produce films, ribbons or particles of metals or alloys including cold rolling, arc melting, resistance heating, ball milling, sputtering, chemical vapor deposition, thermal evaporation, atomization, induction heating or melt spinning. The above described active materials may also be made via the reduction of metal oxides or sulfides.

The present disclosure further relates to methods of making negative electrodes that include the above-described negative electrode compositions. In some embodiments, the method may include mixing the above-described the electrochemically active materials, along with any additives such as binders, conductive diluents, fillers, adhesion promoters, thickening agents for coating viscosity modification and other additives known by those skilled in the art, in a suitable coating solvent such as water or N-methylpyrrolidinone to form a coating dispersion or coating mixture. The dispersion may be mixed thoroughly and then applied to a foil current collector by any appropriate coating technique such as knife coating, notched bar coating, dip coating, spray coating, electrospray coating, or gravure coating. The current collectors may be thin foils of conductive metals such as, for example, copper, aluminum, stainless steel, or nickel foil. The slurry may be coated onto the current collector foil and then allowed to dry in air or vacuum, and optionally by drying in a heated oven, typically at about 80° to about 300° C. for about an hour to remove the solvent.

The present disclosure further relates to methods of making magnesium batteries. In various embodiments, the method may include providing a negative electrode as described above, providing a positive electrode, and incorporating the negative electrode and the positive electrode into a battery comprising a magnesium-containing electrolyte.

The operation of the present disclosure will be further described with regard to the following detailed examples. These examples are offered to further illustrate various specific embodiments and techniques. It should be understood, however, that many variations and modifications may be made while remaining within the scope of the present disclosure.

### EXAMPLES

### Test Methods and Preparation Procedures

### X-Ray Diffraction (XRD) Test Method

XRD measurements on Pb based electrodes were conducted using an ULTIMA IV X-RAY DIFFRACTOMETER, available from Rigaku Americas Corporation, Woodlands, Tex., equipped with a Cu K_{α} radiation source, and a scintillation detector with a graphite diffracted beam monochromator. Measurements were taken from 20 degrees 2-theta, with 0.05 degrees per step, and a 1 second count time. XRD measurements of Pb electrodes were made ex-situ (i.e. after cycling in Conflat cells containing the electrodes at a C/40 rate between 5 mV and 250 mV vs. Mg at 60±0.1° C. for 1 and 1.5 cycles) by disassembling a cell, rinsing the working electrode in THF and drying under vacuum to evaporate the solvent. The electrode was then sealed in an air sensitive X-ray holder under an argon atmosphere prior to XRD measurement.

### Constant Current Cycling Test Method

Cells were cycled at C/40 rate, between 5 mV and 250 mV vs. Mg at 60±0.1° C. for at least 10 cycles using a SERIES 4000 AUTOMATED TEST SYSTEM, available from Maccor, Inc., Tulsa, Okla. Prior to constant current cycling, the cell was initially held at a constant voltage of 5 mV for 3 minutes and then allowed to rest for few minutes at open circuit voltage. If this step was omitted, during cell discharge electrolyte was observed to decompose on the Pb surface and no magnesiation took place. The C-rate was calculated based on the formation of Mg₂Pb at full magnesiation.

### Conflat Cell Preparation Method

2-Electrode Conflat cells equipped with PTFE gaskets (DPM Solutions Inc., Hebbville, Nova Scotia, Canada), were constructed using a sputtered disc or composite lead electrode and Mg foil (99.95%, 0.25 mm thick, Gallium Source, LLC, Scotts Valley, Calif.) counter/reference electrode. Two layers of CELGARD 2300 separator, available from Celgard, LLC, Charlotte, N.C., were used in each cell with a layer of polyethylene blown microfiber (BMF) separator, 0.1 mm thickness, 1.1 mg/cm², available from 3M Company, St. Paul, Minn., in between. An electrolyte solution of 0.5 M ethylmagnesium chloride (EtMgCl, Sigma Aldrich Corporation, St. Louis, Mo.) in tetrahydrofuran (THF, <2 ppm H₂O, 99.9%, inhibitor free, Sigma Aldrich) was used in the cells. All cells were constructed in an argon filled glovebox.

### Example 1

A Pb electrode was prepared by sputter deposition of Pb onto 13 mm stainless steel (SS) foil discs using a modified V-3T sputter deposition system (Corona Vacuum Coaters Inc., Vancouver, British Columbia, Canada). A base pressure of 7.6×10⁻⁷ Torr with a 3.1 mTorr argon pressure and a 35 W target power were used during the deposition process. The SS discs were weighed before and after sputtering using a Satorius SE-2 microbalance (±0.1 μg resolution), available from Satorius AG, Göttingen, Germany, in order to determine the mass of the sputtered Pb film. The average thickness of the sputtered Pb film was 0.24 μm. After sputtering, the discs were transferred immediately in to an argon filled glovebox to minimize the oxidation of Pb. Conflat cells were prepared from the sputter Pb electrode as described in the “Conflat Cell Preparation Method”. The cells were then cycled, disassembled, and ex-situ XRD measurements were performed on the Pb electrodes.

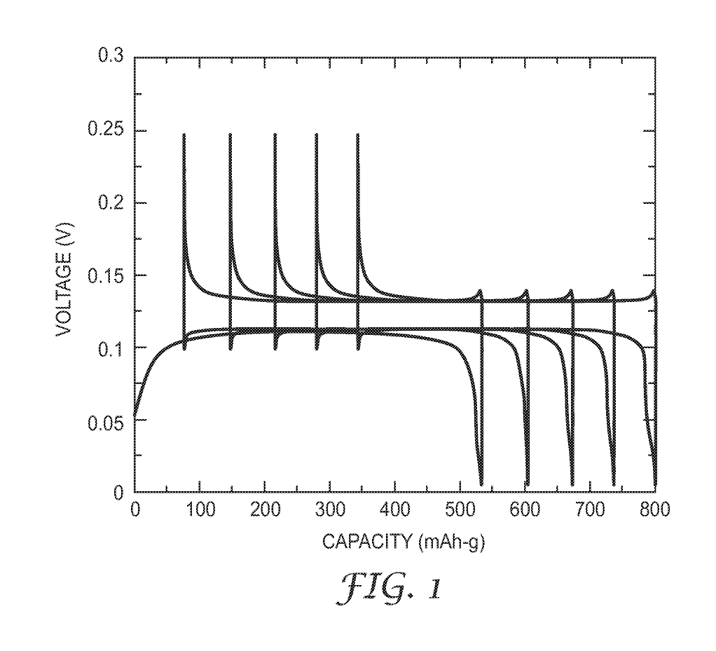

The voltage curve of a sputtered Pb film vs. Mg Conflat cell cycling at C/40 rate is shown in FIG. 1. The voltage curve consisted of a single plateau, indicative of a simple 2-phase reaction. The plateau had a low average voltage of about 125 mV, which was the lowest voltage yet reported for electrochemical magnesiation of a metal. Voltage polarization during cycling was also low for an alloy (˜25 mV), indicating good kinetics. The reversible capacity for magnesiation was about 450 mAh/g. This was slightly less than the theoretical capacity for the formation of Mg₂Pb (517 mAh/g). This difference may be attributed to weighing error. The formation of Mg₂Pb corresponds to a rather large volumetric capacity of about 2200 AWL, which was three times greater than that of graphite in a lithium ion cell and was the highest volumetric capacity reported for a magnesium alloy.

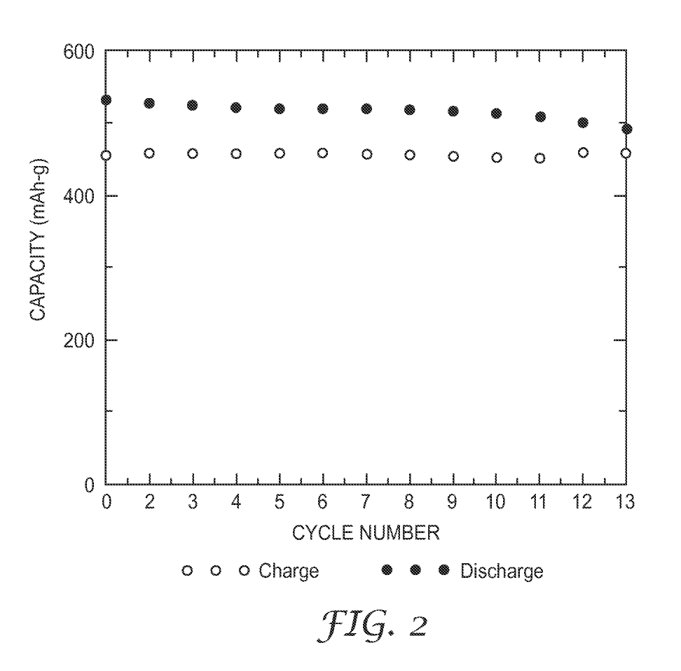

FIG. 2 shows the cycling performance of the same sputtered Pb film electrode vs. Mg Conflat cell as shown in FIG. 1. Little capacity fade is observed over 13 charge/discharge cycles.

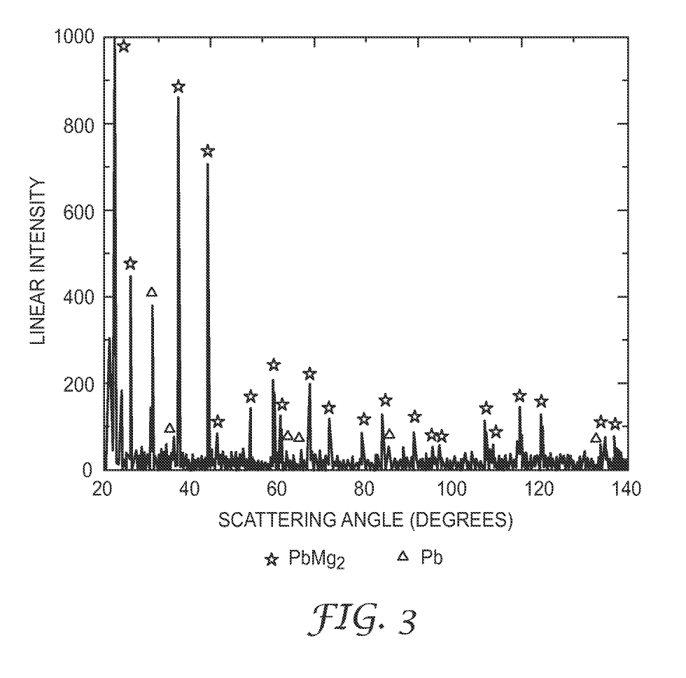

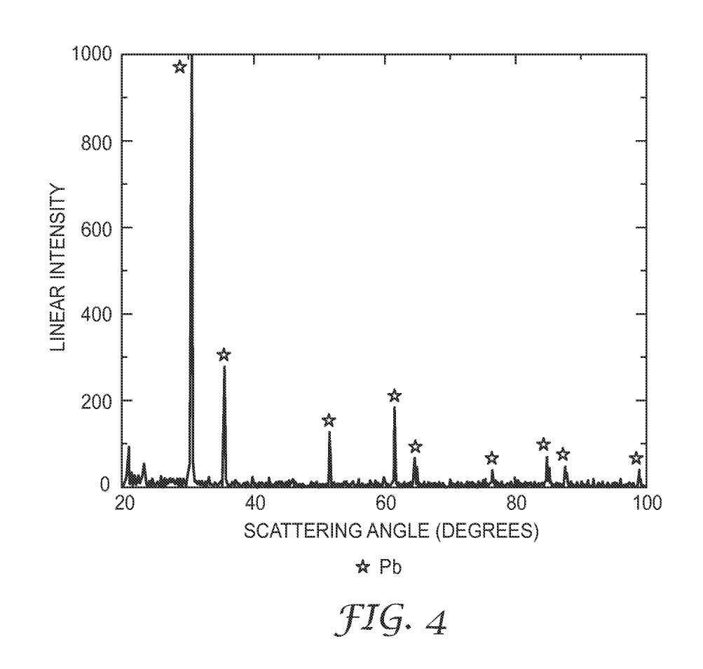

Ex-situ XRD patterns of sputtered Pb films that had been cycled in Mg cells under the same conditions as the cell previously described were measured to determine the mechanism of Pb magnesiation. The ex-situ XRD pattern of a sputtered Pb film that was removed from a fully discharged Conflat cell is shown in FIG. 3. The XRD pattern corresponds to the formation of Mg₂Pb with a minor amount of unmagnesiated Pb. FIG. 4 shows the XRD pattern of a sputtered Pb film that was removed from a Conflat cell which had been fully discharged, then charged. The XRD pattern corresponds to that of Pb. The ex-situ XRD results indicate that Mg₂Pb forms during the magnesiation of Pb and during demagnesiation Pb is re-formed.

### Example 2

Composite electrodes were made from Pb powder (˜325 mesh, 99%, Sigma Aldrich), poly(vinylidene fluoride) (KYNAR PVDF HSV 900, Arkamea, King Of Prussia, Pa.) and Super P carbon black (EraChem, Europe) in a 80/10/10 mass ratio and cast from NMP (anhydrous 99.5%, Sigma Aldrich) onto stainless steel foil, followed by air drying at 120° C. for 2 hours. The average electrode loading was 2.4 mg/cm².

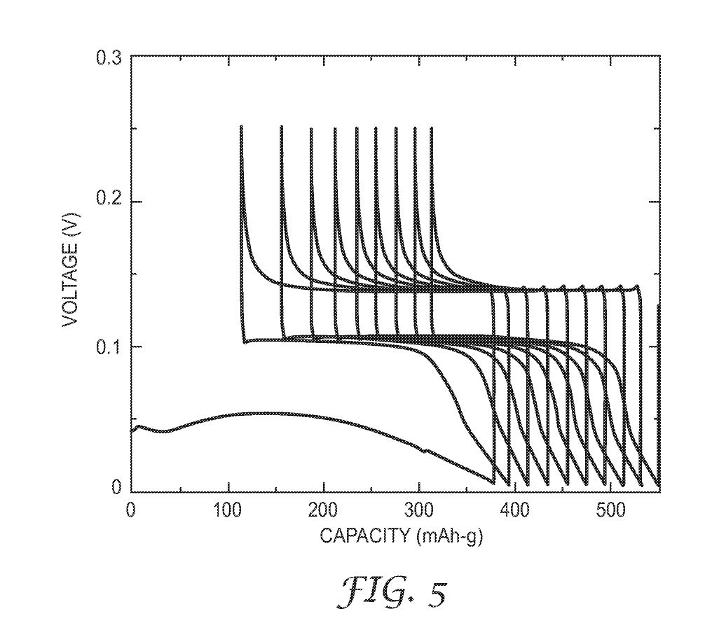

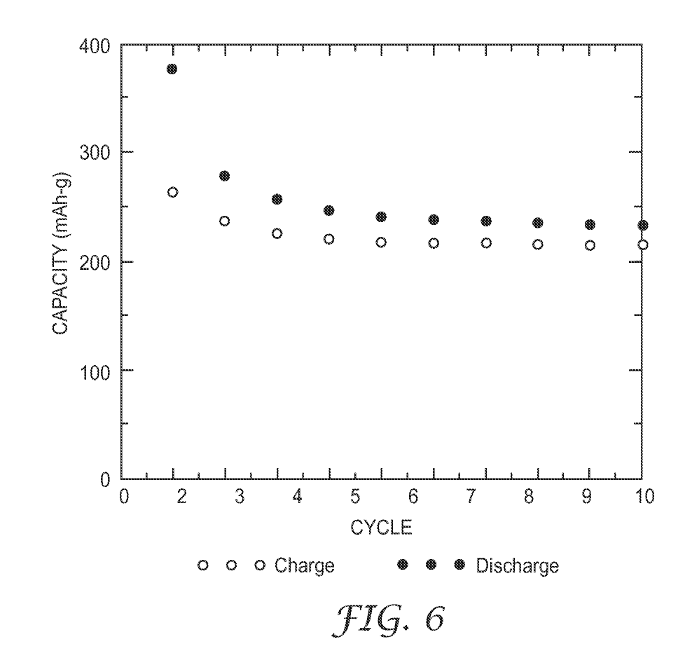

Conflat cells were prepared from the composite Pb electrode as described in the “Conflat Cell Preparation Method”. The cells were then cycled in the same manner as in Example 1 (C/40 rate), including the 5 mV hold for 3 minutes prior to cycling. FIGS. 5 and 6 show the cycling performance and capacity performance of the Pb composite electrode. The cell cycled reversibly. The voltage curve was similar to the sputtered Pb electrode of Example 1, except the capacity was much less. This may have been due to the large particle size of the Pb particles, compared to the sputtered film used in the previous example, which lead to only partial magnesiation of the electrode.

1. An electrochemically active material, the material comprising:
an electrochemically active phase comprising elemental Pb;
wherein the electrochemically active material comprises at least 20 atomic % elemental lead based on the total chemical composition of the electrochemically active material.

2. The electrochemically active material of claim 1, further comprising an inactive phase comprising one or more of Ti, V, Cr, Fe, Mn, Fe, Co, Ni, Cu, Al, Si, Zn, or combinations thereof.

3. The electrochemically active material of claim 1, wherein the electrochemically active phase further comprises electrochemically inactive elements including one or more of Ti, V, Cr, Fe, Mn, Fe, Co, Ni or combinations thereof.

4. The electrochemically active material of claim 1, wherein the electrochemically active material further comprises Sn, Bi, Sb, S, or combinations thereof.

5. The electrochemically active material of claim 1, wherein the electrochemically active material further comprises Mg.

6. The electrochemically active material of claim 1, wherein the electrochemically active material consists essentially of elemental lead.

7. A magnesium battery comprising:
a positive electrode comprising a positive electrode composition;
an electrolyte comprising magnesium; and
a negative electrode comprising a negative electrode composition comprising the electrochemically active material of claim 1.

8. An electronic device comprising a magnesium battery according to claim 7.

9. A method of making a magnesium battery, the method comprising:
providing a positive electrode comprising a positive electrode composition;
providing a negative electrode comprising a negative electrode composition comprising the electrochemically active material of claim 1;
providing an electrolyte comprising magnesium; and
incorporating the positive electrode, negative electrode, and the electrolyte into a battery.
